(19) United States
(12) Patent Application Publication
(10) Pub. No.: US 2026/0276672 A1
(43) Pub. Date: Sep. 17, 2026

(54) Nano-Probe Thermoreflectance Microscopy

(71) Applicant: Laser Thermal Analysis, Inc., Charlottesville, VA (US)

(72) Inventors: Brian M. Foley, Charlottesville, VA (US); Andrew H. Jones, Charlottesville, VA (US); Patrick E. Hopkins, Charlottesville, VA (US); John T. Gaskins, Charlottesville, VA (US)

(73) Assignee: Laser Thermal Analysis, Inc., Charlottesville, VA (US)

(21) Appl. No.: 19/472,191

(22) PCT Filed: Apr. 5, 2024
(86) PCT No.: PCT/US2024/023325

§ 371 Date: Oct. 3, 2025

Related U.S. Application Data
(60) Provisional application No. 63/494,299, filed on Apr. 5, 2023.

(51) Int. Cl. G01Q 60/58; G01K 11/125; G01N 25/18; G01Q 70/10; G01Q 70/14

(52) U.S. Cl. CPC G01Q 60/58; G01K 11/125; G01N 25/18; G01Q 70/10; G01Q 70/14

(57) ABSTRACT

A nano-probe thermoreflectance microscope (NTM) can measure the thermal resistance of a GaN transistor or other device or sample with micron-scale spatial resolution. An NTM includes an atomic force microscopy (ATM) probe whose tip touches the sample. Either the ATM probe or the sample is heated, causing heat to flow between the sample and the ATM probe. This causes the temperature of the ATM probe to fluctuate. These temperature fluctuations cause the ATM probe's thermoreflectance to fluctuate in turn. An NTM measures the thermoreflectance fluctuations with a probe laser beam. If desired, a lock-in amplifier can modulate the heat flux between the ATM probe and sample, e.g., by modulating a stage that pushes the sample against the ATM probe, by modulating the amplitude of a pump laser beam focused on the ATM probe, or by modulating the drive current of the device under test, producing an amplitude modulation of the reflected probe laser beam at the same frequency.

### CROSS-REFERENCE TO RELATED APPLICATION(S)

This application claims the priority benefit, under 35 U.S.C. 119(e), of U.S. Application No. 63/494,299, filed on Apr. 5, 2023, which is incorporated herein by reference in its entirety for all purposes.

### BACKGROUND

High-precision thermal metrology can be used to characterize thermophysical properties of nanoscale electronic devices (nanodevices), such as high-electron-mobility transistors (HEMTs) and light-emitting diodes (LEDs). These thermophysical properties, which include thermal conductivity, thermal resistance, and specific heat capacity of materials, are useful for understanding heat flow in nanodevices. Thermal metrology can also be used to identify where heat is generated within a nanodevice, e.g., due to power dissipation/loss. Undesired heat generation can affect the performance and reliability of the nanodevice. By measuring the temperature of the nanodevice and the heat generated within the nanodevice, thermal metrology can provide insights into the sources of heat generation and how to reduce undesired heat generation.

In addition to the design and optimization of nanodevices, thermal metrology can also be used for evaluating the performance of nanodevices. By measuring the temperature of a nanodevice during operation, it is possible to determine whether the nanodevice is operating within safe temperature limits. If a nanodevice's temperature exceeds a certain threshold, the nanodevice can suffer thermal damage, which can significantly reduce the nanodevice's lifetime and degrade the nanodevice's performance. Therefore, thermal metrology can be used to ensure the reliability and longevity of nanodevices.

### SUMMARY

Nano-probe thermoreflectance microscopy (NTM) provides high-resolution thermal metrology suitable for accurately characterizing the thermophysical properties and absolute temperature of a wide variety of films, material structures, devices, and packages used in transistors and other nanodevices. This thermal characterization data can be incorporated into nanodevice modeling and design, enabling HEMTs and other nanodevices with higher power density and improved robustness for a wide range of defense and commercial radar and communication applications.

Nano-probe thermoreflectance microscopy can be used for accurate characterization of the thermal resistance and/or absolute surface temperature of different semiconductor materials, heterostructures, and devices, including wide bandgap and ultra-wide bandgap materials and devices at the nanometer length scale. Examples of a nano-probe thermoreflectance microscope can measure both epilayers and operating devices with a thermal resolution finer than 0.25° C., thermal precision of 1° C., spatial resolution finer than 50 nm, accuracy above 90%, and reproducibility and repeatability of less than 2%. A nano-probe thermoreflectance microscope can measure thermal resistance, thermal boundary resistance of interfaces, and/or (absolute surface) temperature of an operating device and, in particular, buried channel layers. Device-scale measurements made by a nano-probe thermoreflectance microscope can characterize the surfaces and cross-sections of sophisticated semiconductor nanodevices, such as multi-finger, submicron GaN HEMTs and ultra-wide bandgap AlGaN HEMTs.

Nano-probe thermoreflectance microscopy can be used to measure the thermal resistance and/or absolute surface temperature of a sample as follows. An atomic force microscope (AFM) probe tip is placed in direct contact with the sample, which may be a semiconductor material or a nanoscale electronic device (e.g., a transistor or LED). The surface area of the AFM probe tip in direct contact with the sample is modulated, e.g., by moving the sample toward and away from the AFM probe tip or vice versa, so as to vary the heat flux between the AFM probe tip and the sample by changing the contact area between the AFM probe tip and the sample. The heat flux can also be varied by modulating the intensity of a heating beam that illuminates the sample or, if the sample is an active device, such as a transistor or LED, by modulating the current used to drive the device. The sample can be hotter than the AFM probe tip, in which case heat flows from the sample to the AFM probe tip, or the AFM probe tip can be heated to a temperature hotter than the temperature of the sample with a laser beam absorbed by the AFM probe tip, in which case heat flows from the AFM probe tip to the sample.

While the surface area of the AFM probe tip in direct contact with the sample is modulated, the modulation of the AFM probe tip's temperature caused by variation in the heat flux between the AFM probe tip and the sample is measured, e.g., based on a modulation of the thermoreflectance of a surface of a cantilever portion of the AFM probe tip. In general, measuring the modulation of the temperature associated with a particular frequency component of the tip-sample heat flux may include performing a lock-in measurement while perturbing the thermal system via any or all of the aforementioned methods. For instance, temperature changes related to the tip-sample heat flux and detected via thermoreflectance could arise via frequency and/or amplitude modulation of the amount of surface area of the AFM probe tip in direct contact with the sample, the laser power delivered by a pump beam that illuminates the cantilever portion of the AFM probe tip, or a drive current applied to the sample. Due to the non-linear nature of the tip-sample contact mechanics, frequency components of the tip-sample heat flux that are different from the modulation drive frequencies could also arise via frequency-beating and/or mixing, causing temperature changes at intermediate frequencies that are quantified via thermoreflectance and lock-in detection. The thermal resistance or absolute temperature of the sample can be estimated based on the modulation of the AFM probe tip's temperature for a given perturbation scheme or combination of perturbation schemes.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates a nano-probe thermoreflectance microscope (NTM).

FIG. 1B shows the atomic force microscope (AFM) probe of the NTM of FIG. 1A being used to make an active-mode measurement of a sample.

FIG. 2A illustrates passive-mode for measuring temperature in operando of a GaN LED (top-left, in NTM system) cycled between lower/higher drive states, resulting in a modulation of the device temperature.

FIG. 2B is a plot that shows the temperature of the Cu-core printed circuit board (PCB) that the GaN LED in FIG. 2A is mounted to via a thermistor (left axis) and a thermoreflectance signal from an NTM (right axis), demonstrating the ability to detect changes in device temperature at ≤100 nm pixel resolution.

FIG. 3A is a plot of thermoreflectance versus the force modulation drive amplitude for the piezoelectric stage in an NTM for a bulk SiO₂ calibration sample (upper trace) and an MoS₂ monolayer on an SiO₂ substrate (lower trace).

FIG. 3B is a plot of thermoreflectance versus the force modulation drive amplitude for the piezoelectric stage in an NTM for a bulk MgO calibration sample (upper trace) and a 5-micron-thick GaN layer on an Al₂O₃ substrate (lower trace).

FIG. 4A shows thermoreflectance maps of monolayer MoS₂ triangles grown on SiO₂/Si substrates, yielding both 200 nm (left) and 34 nm (right) pixel resolution depending on scan area size and pixel count. Darker areas indicate lower thermoreflectance signal (ergo, lower tip temperature) due to more conductive material in the probed volume.

FIG. 4B is a thermoreflectance map collected at the end of a gate finger on a GaAs pHEMT (ADPA7007 MMIC) also imaged with a Laser Thermal SSTR-F instrument. Source and drain connections to the channel, as well as the gate finger obscuring the region in this particular K/Ka band device are clearly identifiable at 110 nm pixel resolution.

FIG. 5 is a diagram of the tip-sample interaction considered in the Hertzian contact model for a spherical indenter brought into contact with a semi-infinite material half-space. The inset is an SEM image of a spherical tip used in an NTM, highlighting the geometric consistency with the Hertz model.

FIG. 6A illustrates tip-sample contact radii considerations and their impact on the probing depth of the thermal volume. Spherical tips (left) with contact radii determined via the Hertz or other contact mechanics model are well suited for increasing surface sensitivity due to shallow probing volumes, while plateau tips (right) where the contact radius is the same as the plateau radius enable deeper thermal penetration into the material stack.

FIG. 6B shows sample cross sections that can enable measurement of thermal resistances at buried interfaces, particularly in situations where highly-resistive material layers would otherwise obscure the ability to probe deep heterointerfaces of interest from the top surface.

### DETAILED DESCRIPTION

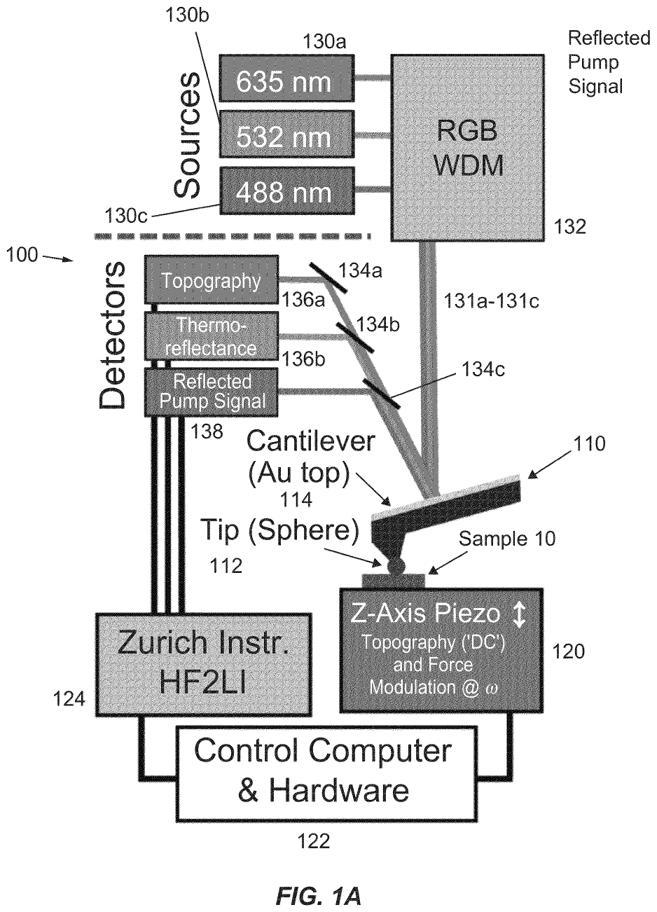

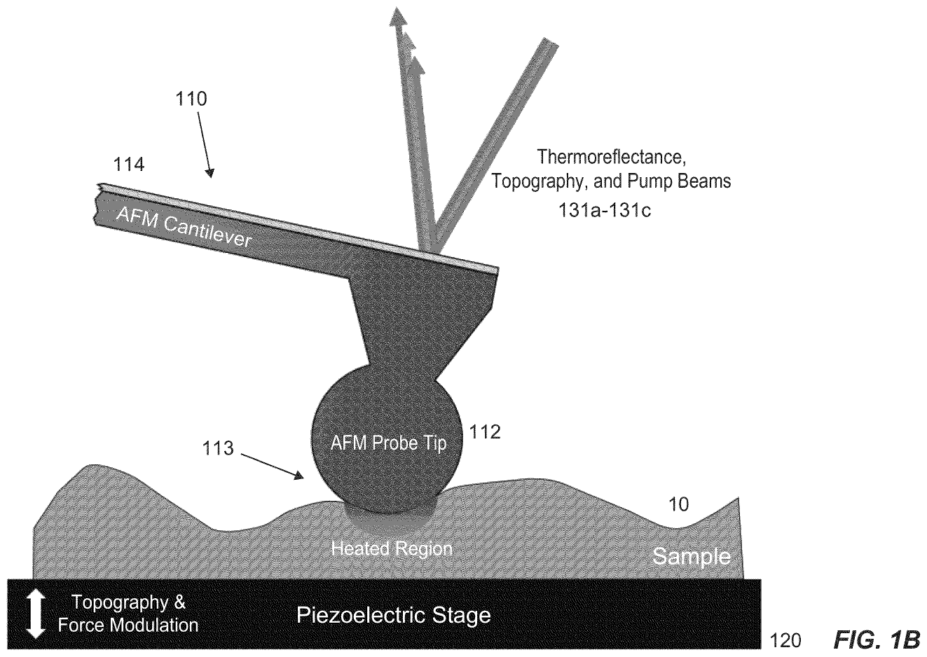

FIGS. 1A and 1B illustrate a nano-probe thermoreflectance microscope (NTM) 100. As shown in FIG. 1A, the NTM 100 includes an atomic force microscope (AFM) probe 110 with a spherical probe tip 112 at one end of a gold-coated cantilever 114. The cantilever 114 holds the spherical probe tip 112 against one surface of a sample 10, such as sample of material or a transistor or other nanodevice, that is positioned on a piezoelectric stage 120. The piezoelectric stage 120 can hold the sample 10 in either a horizontal orientation or a vertical orientation. The piezoelectric stage 120 may have a versatile arrangement of mounting holes/patterns to facilitate mounting of evaluation boards containing die that are wire bonded to traces and/or package feedthroughs, as well as appropriate radio frequency (RF) and direct current (DC) connections (e.g., board-mount female SMA connections for RF signals and simple header pins for DC bias).

The piezoelectric stage 120 can translate the sample 10 up and down so as to push the sample 10 against the probe tip 112, changing the size of the contact area 113 at the interface or junction between the sample 10 and the probe tip 112 via force modulation. When operating to modulate the contact area 113, for example, the piezoelectric stage 120 can move up and down, displacing 5 nm to 50 nm from its initial position while in contact with the sample, corresponding to a small-signal (e.g., <10%) dilation of the tip-sample contact area 113, which depends on the average applied force and the elastic moduli and Poisson's ratios of the tip and sample materials in contact with each other. The piezoelectric stage 120 can also move the sample 10 laterally with respect to the probe tip 112, e.g., for a scanning measurement as described below. The piezoelectric stage's vertical and horizontal positions are controlled by a processor, shown in FIG. 1A as a control computer 122, and/or other suitable hardware.

The NTM 100 also includes one or more lasers, shown in FIG. 1A as a red, green, and blue lasers 130a-130c that emit red, green, and blue (RGB) laser beams 131a-131c (collectively, laser beams 131) at wavelengths of 635 nm, 532 nm, and 488 nm, respectively. The wavelengths of the laser beams may be selected to produce the desired absorption by and thermoreflectance from the surface of the cantilever 114. In this example, the cantilever 114 is coated with gold, which absorbs green and blue light and reflects red light, while also providing strong thermoreflectance responses detected via green and/or blue light. Other materials, such as aluminum or tantalum, may work better with light at other wavelengths. In operation, the NTM 100 uses the red and green laser beams 131a, 131b to measure the position and thermoreflectance, respectively, of the AFM probe 110. In active mode (described below), the blue laser beam 131c is on and heats the cantilever 114 to generate a thermal gradient across the tip/sample interface. (The NTM 100 can also use the green laser beam 131b for heating and the blue laser beam 131c for thermoreflectance measurements.) An RGB wavelength division multiplexer (WDM) 132 multiplexes these laser beams 131 so they propagate along a common optical path before being focused to (possibly coincident or overlapping) spots on the gold-coated surface of the cantilever 114.

The gold-coated surface of the cantilever 114 absorbs some of the incident laser light and reflects or scatters the rest. In this case, the cantilever 114 absorbs most of the blue laser beam 131c and reflects most of the red laser beam 131a and green laser beam 131b. Dichroic beam splitters 134a-134c direct different portions of the reflected or scattered laser light to respective photodetectors 136a-136c. In this case, dichroic beam splitter 134c directs reflected/scattered blue laser light to the photodetector 136c and transmits red and green laser light; dichroic beam splitter 134b directs reflected/scattered green laser light to photodetector 136b and transmits red laser light; and dichroic beam splitter 134a (which could also be a simple mirror) directs reflected/scattered red laser light to photodetector 136a. (Alternatively, dichroic beam splitter 134c can directed the reflected/scattered blue laser light to a beam dump instead of to photodetector 136c.)

The photodetector 136a that detects red laser light is a position-sensitive quadrant photodetector and is operably coupled to the control computer 122. The control computer 122 determines the vertical deflection of the AFM probe 110 due to local height variations of the sample 10 surface from the signal generated by the photodetector 136a that detects the reflected red laser light. The control computer 122 can also use the signal generated by the photodetector 136a in response to the reflected red laser light to map out the topography of the sample 10 via closed-loop feedback to the piezoelectric stage 120.

The photodetector 136b that detects green laser light is operably coupled to a lock-in amplifier 124, which is coupled in turn to the control computer 122 and/or piezoelectric stage 120. The lock-in amplifier 124 extracts a thermoreflectance signal from the output of the photodetector 136. This thermoreflectance signal is proportional to temperature changes due to modulation of the tip-sample heat flux at any/all frequencies and/or frequency products through the aforementioned modulation methods.

The photodetector 136c that detects blue laser light is operably coupled to the control computer 122. The control computer 122 uses the signal from the photodetector 136c to monitor system stability, noise spectra, the amplitude and phase of the pump modulation signal, etc. For instance, if the control computer 122 modulates the amplitude or intensity of the pump beam 131c to vary the heat flux between the sample 10 and the AFM probe 110, the control computer 122 can detect, quantify, control, and optimize that modulation based on the waveform of the reflected/scattered pump light detected by the photodetector 136c.

In other implementations, these functions can be performed with more or fewer laser beams, e.g., a single laser beam or a pair of laser beams. For example, one laser beam can heat the cantilever surface, and another laser beam can reflect off it to provide both thermoreflectance and position information. Alternatively, one laser beam can heat the cantilever surface and scatter or reflect off the cantilever's surface to provide thermoreflectance information, and another laser beam can reflect off the cantilever's surface to provide position information. Or a single laser can illuminate the cantilever with a laser beam at a wavelength that is partially absorbed and partially scattered or reflected by the cantilever, providing both heating and thermoreflectance detection. One or more photodetectors detect the scattered/reflected light. These photodetectors generate signals that represent the cantilever's position and top surface temperature via thermoreflectance.

The NTM 100 in FIGS. 1A and 1B can operate in both active and passive modes. The active and passive modes of operation are performed using the same microscopy assembly, meaning that the sample 10 is mounted to the same piezo-scanning stage 120 and probed with the same optical assembly where laser beams are routed to and from the top surface of the cantilever probe 114 that contacts the sample 10. Where both modes utilize changes in thermoreflectance to monitor the temperature of the cantilever surface, they differ with regard to the location of the heat source(s). In active mode, the cantilever 114 is heated by a pump laser beam (here, the blue laser beam 131c) to establish a thermal gradient between the tip 112 and the sample 10, driving a heat flux across the contact area 113 from the tip 112 to the sample 10. In passive mode, the sample 10 is heated (e.g., by self-heating during operation in cases where the sample is a semiconductor device, such as a transistor or LED) to establish a thermal gradient in the opposite direction and drive heat across this same tip/sample contact area 113 from the device into the cantilever 114.

In both active and passive modes, the tip/sample contact area 113 can be dilated periodically, e.g., via force modulation with the stage 120 supporting the sample 10, to create a time-varying oscillation in the heat flux between the sample 10 and the tip 112 and hence in the cantilever's temperature. In active mode, the pump laser beam can be pulsed or modulated to vary the temperature of the tip 112 and hence the heat flux between the tip 112 and the sample 10 instead of or in addition to modulation of the tip/sample contact area 113. Similarly, in passive mode, the temperature of the sample 10 can be modulated (e.g., for a semiconductor device, by varying the drive current) to vary the sample temperature and hence the heat flux between the tip 112 and the sample 10 instead of or in addition to modulation of the tip/sample contact area 113.

Variation in the tip's temperature causes a corresponding variation in the thermoreflectance of the cantilever's outer surface, which can be coated with gold, aluminum, or another suitable material. The change in thermoreflectance can be detected with a probe laser beam (here, green laser beam 131b), which may be degenerate with the pump laser beam used to heat the cantilever 114 in active mode (i.e., the same laser beam can both heat the cantilever and measure its change in thermoreflectance). In passive mode, the probe laser beam can detect temperature oscillations at the cantilever surface via changes in thermoreflectance due to either the Joule-heating of the sample 10 (device under test) directly via the electronic drive at a set frequency, or force modulation and tip/sample contact radii dilation at a frequency independent from the operating conditions (frequency, amplitude, phase, pulse shape/width, etc.) of the Joule-heated device.

An NTM can be implemented as a turn-key, push-button, automated thermal metrology system similar to the SSTR-F thermal metrology tool from Laser Thermal. Such an automated thermal metrology system can be housed in a free-standing enclosure with a single 15-amp-rated electrical receptacle and connections to radio-frequency (RF) testing apparatus. In some examples, the NTM may include or be operably coupled to a vacuum chamber that holds the sample/device being measured. The vacuum chamber reduces or eliminates (a) convective coupling via air between the device under test and the NTM cantilever structure and (b) measurement instability otherwise caused by environmental factors in ambient (changes in air temperature, air flow, etc.). Additionally, the heating elements and temperature sensors can be integrated into both the sample mounting stage and the probe holder to enable careful control and equalization of the cantilever temperature when performing a thermoreflectance calibration for signal magnitude versus temperature.

### Active-Mode NTM Measurements

FIG. 1B illustrates how the nano-probe thermoreflectance microscope 100 monitors the surface topography of a sample 10, such as a test material, transistor, LED, or other nano-scale electronic device, in active mode. In an NTM, the scanning probe tip 112 at the end of a cantilever beam 114 is brought into contact with the sample 10 (e.g., a HEMT) and moved across the sample's surface, following the topography via contact-mode atomic force microscopy (AFM). In active mode, the cantilever 114 is heated by a pump/probe laser beam (blue laser beam 131c). This pump/probe laser beam can be either modulated or unmodulated and either pulsed or continuous wave, depending on whether or not it is used to modulated the temperature of the cantilever 114. At the same time, the piezoelectric stage 120 moves the sample 10 up and down (toward and away from the probe tip), causing the contact area and thermal resistance between the probe tip 112 and sample 10 to fluctuate. Changes in the local thermal resistance at the tip/sample junction 113 result in commensurate changes to the heat flux across the tip/sample contact 113, and by association in the absolute surface temperature on the top side of the cantilever 114. These temperature changes are detected via thermoreflectance measurements with a reflected portion of the pump beam 131c or a separate probe beam 131b. By varying the magnitude of the heat flux across the tip/sample junction 113, the associated change in amplitude of the temperature oscillation can be used to determine the thermal resistance and/or absolute surface temperature of the probed sample volume.

### Passive-Mode NTM Measurements

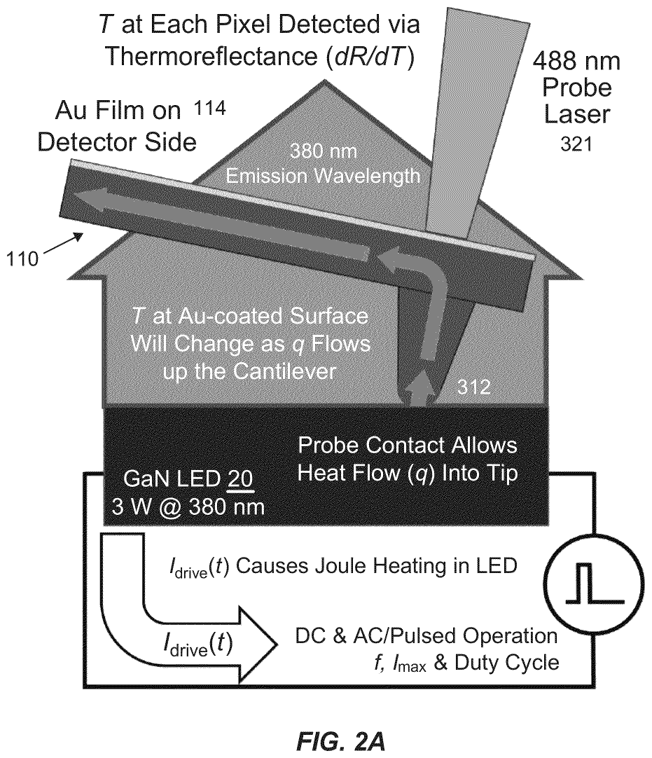

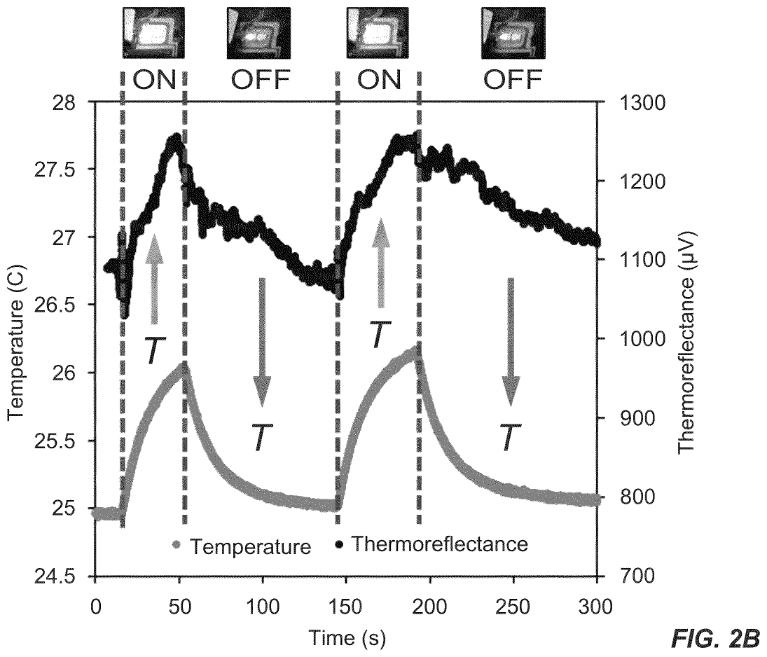

FIGS. 2A and 2B illustrate the NTM 100 being used in passive mode to measure thermal properties of a gallium nitride (GaN) LED 30 as it is turned on and off. FIG. 2A shows how the LED 30 gets hot due to Joule-heating during operation, causing heat to flow through the tip area in contact with the device surface, thereby altering the temperature of the cantilever probe 110 itself. The NTM 100 detects an oscillating temperature at the cantilever surface related to the device temperature via two methods: first, by modulating the drive current (I_{drive}(t)) to the LED 30, resulting in periodic Joule heating at a known frequency, fⱼₒᵤₗₑ (e.g., from hertz to Gigahertz), that the lock-in amplifier 124 (FIG. 1A) can detect and extract from the output of the photodetector 136b that senses the reflected probe signal, or second, by force modulation (as in active mode) via the movement of the Z-piezo stage 120 at a known frequency, f_{mod} (e.g., from tens of hertz to hundreds of Megahertz), that can be completely independent from any of the device operation parameters. With a priori knowledge of these frequencies, changes in the temperature of the top cantilever surface, which are indicative of temperature variations at the point of the contact between the tip and the device surface, can be detected via the thermoreflectance of the top cantilever surface.

FIG. 2B is a plot of the temperature (left axis) and thermoreflectance (right axis) versus time as the LED 30 is cycled on and off as shown in the pictures of the LED above the plot. The use of thermoreflectance as an approach for temperature sensing has been utilized to great effect in a variety of metrologies, including time-domain thermoreflectance (TDTR) and frequency-domain thermoreflectance (FDTR), as well as transient thermal imaging. In this way, temperature changes on the order of fractions of a Kelvin can be detected. Given the NTM's exceptional temperature sensitivity, it is possible to drive the LED 30 with a variety of schemes ranging from pulsed to CW operation with the addition of a small low-frequency ripple current to enable temperature detection by the NTM 100 (e.g., a ripple that ranges in amplitude from 0.1% to 100% of the time-averaged signal magnitude and in frequency from hertz to hundreds of Megahertz).

The control computer 122 can also monitor and control the sample (e.g., an HEMT or LED) in passive mode. For instance, if the sample is a HEMT operated at X-band frequencies, the control computer 122 and associated hardware can control and/or supply a DC bias and an X-band input to the HEMT. During in operando thermal measurements, the NTM 100 can monitor and record HEMT electrical parameters throughout the acquisition. These electrical data can be used to identify and explain anomalous behavior in the RF performance of the HEMT, e.g., due to parasitic capacitances introduced when performing the scanning probe measurements.

### NTM for Steady-State Thermoreflectance (SSTR) Measurements

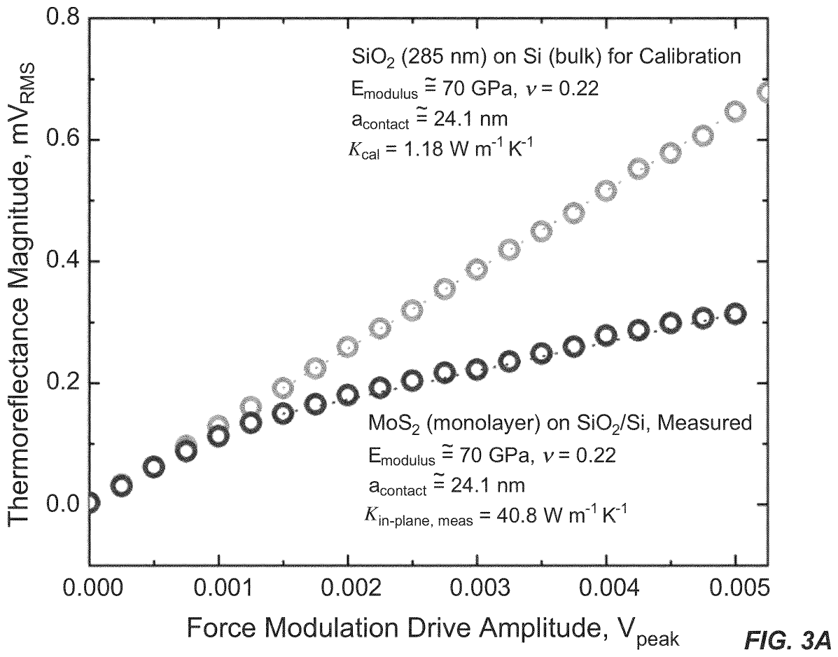

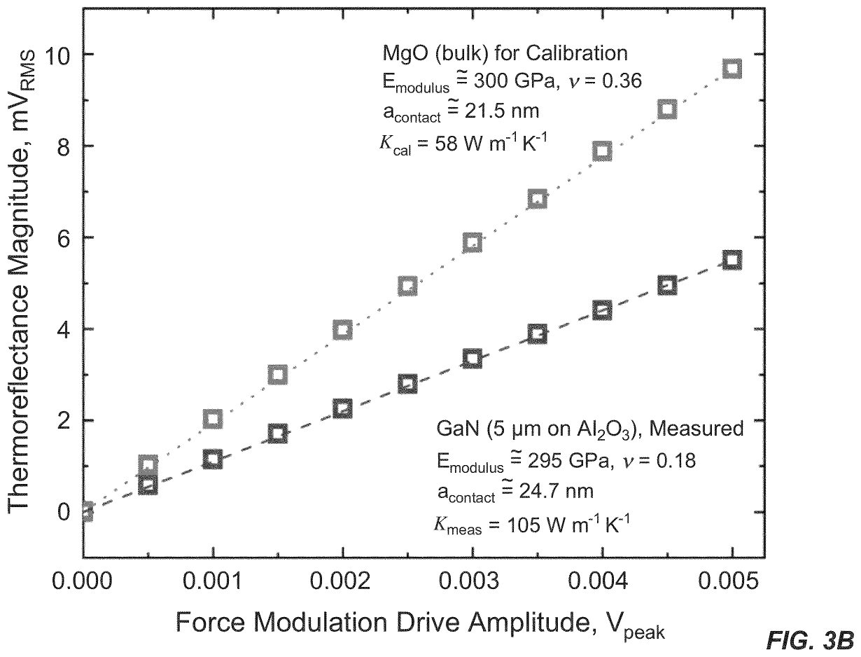

FIGS. 3A and 3B are plots of steady-state thermoreflectance (SSTR) data collected at single points on a given sample with an NTM, assessing the thermal properties of monolayer MoS₂ and 5 μm thick GaN, respectively (lower traces). Both plots also show data for calibration samples (upper traces). In these cases, 285 nm of thermal-oxide grown on silicon (SiO₂/Si) and a MgO substrate serve as thermal conductivity (K) standards for the thermoreflectance measurements of MoS₂ and GaN, respectively. The slopes of the linear regions of the plotted curves provide a direct measurement of the thermal resistance of the probed volume beneath the NTM probe tip relative to the resistance of a known calibration standard. By fitting the acquired data to a multilayer thermal model, material properties such as in-plane and cross-plane K, as well as thermal boundary resistance between adjacent material layers can be extracted.

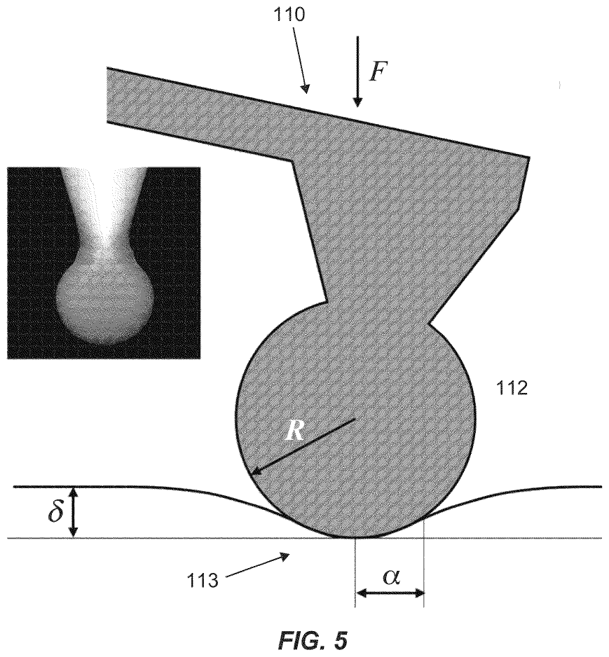

FIG. 3A shows an in-plane thermal conductivity of κ~41 W m⁻¹ K⁻¹ for monolayer MoS₂, consistent with reported values ranging from 35-50 W m⁻¹ K⁻¹ for supported monolayers. FIG. 3B shows an isotropically averaged κ of 105 W m⁻¹ K⁻¹ for 5 μm thick GaN grown on Al₂O₃. While values on this order have been reported in GaN layers≤3 μm thick with dislocation densities of 10⁹ cm⁻² or more, the probing depth of the NTM is approximately equal to the contact diameter between the tip and the sample. As highlighted in FIG. 3B and determined via the Hertzian contact model shown in FIG. 5 (described below), the contact diameter is estimated to be about 22 nm. Therefore, the thermal conductivity value obtained via NTM may be particularly sensitive to the complex defect morphology at the surface of the epi-layer. As a result, NTM can provide a truer assessment of the thermal transport properties in the vicinity of the probed surface. This truer assessment is very useful for understanding and improving lateral thermal relief in devices with planar architectures such as HEMTs.

NTM extends this single-spot SSTR methodology shown in FIGS. 3A and 3B to a pixel-by-pixel scanning approach. Scanning can be accomplished by keeping the AFM tip stationary and moving the sample back and forth (e.g., in a raster pattern) beneath the tip, by moving the tip back and forth across the sample, or both. The scan speed can range from 0.01 pixels to 100 pixels per second, which corresponds to a pixel dwell time ranging from 0.01 seconds to 100 seconds. An NTM can acquire full images exhibiting remarkable contrast in thermal behavior of materials and device elements at spatial resolutions ranging from 30-200 nm, depending on the tip-sample contact area, scan area dimensions and desired pixel resolution.

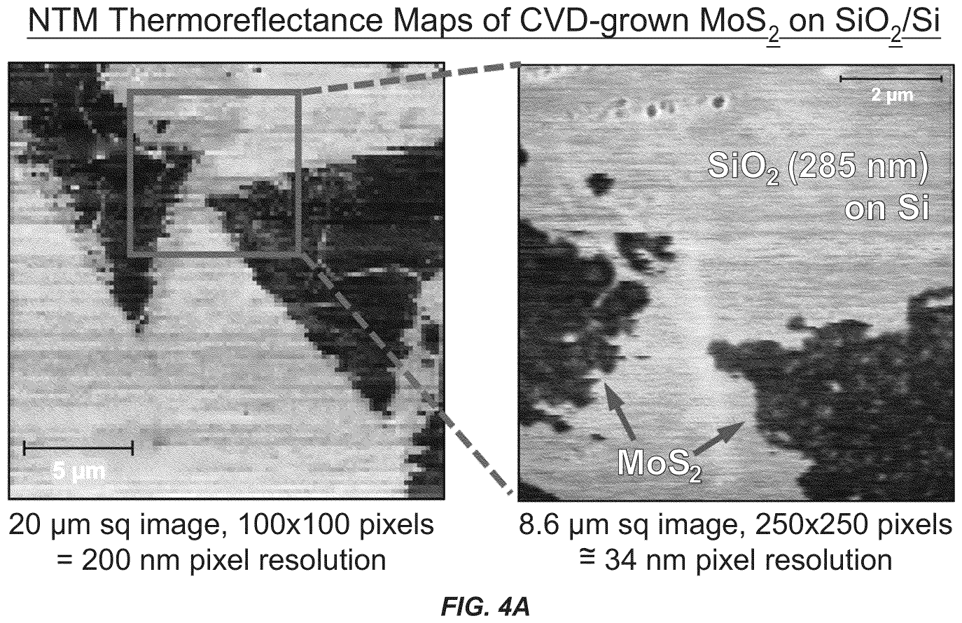

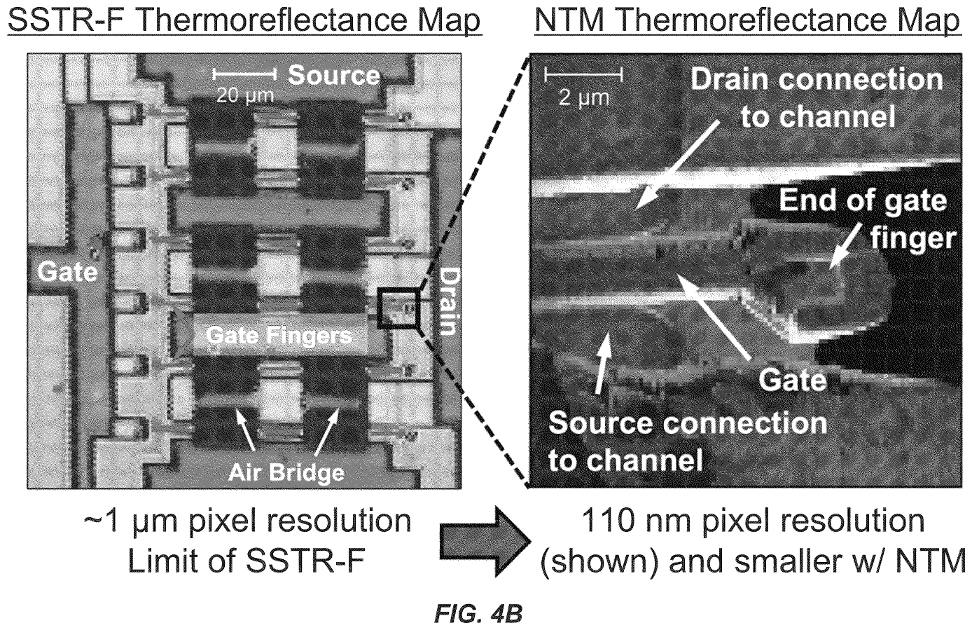

FIG. 4A is an NTM image of monolayer MoS₂ triangles grown on a SiO₂/Si supporting substrate. In FIG. 4A, darker areas indicate lower thermoreflectance signals acquired via the NTM. In other words, the top surface of the cantilever was cooler at the darker pixels than at the brighter pixels. A cooler cantilever for a constant absorbed laser power and average applied force means that the thermal resistance and absolute surface temperature of the material beneath the tip were lower in these regions; conversely a warmer cantilever means that the thermal resistance and absolute surface temperature were higher. In the case of the MoS₂ on SiO₂/Si, the darker areas correspond to the roughly 40 W m⁻¹ K⁻¹ MoS₂ and the brighter areas to the 1.18 W m⁻¹ K⁻¹ SiO₂ layer, determined from the data in FIG. 3A. In practice, the amplitude sweeps plotted in FIG. 3A can be performed at each pixel in FIG. 4A, enabling a pixel-by-pixel determination of local thermal resistance and/or absolute surface temperature.

FIG. 4B shows a thermal image (right) collected with an NTM of a particular area from a GaAs pHEMT (left) imaged with a Laser Thermal SSTR-F instrument. Specifically, the NTM thermal image shows one end of a gate finger in the SSTR-F scan. The NTM thermal image shows the gate, source, and drain connections leading to the channel region (the channel itself is obscured due to its short length in this K/Ka band MMIC). As in FIG. 4A, brighter areas correspond to higher thermal resistances and darker areas correspond to lower thermal resistances. The GaAs pHEMT is likely encapsulated by a thick protective layer; nevertheless, FIG. 4B shows a slight contrast between metal contact areas and semiconductor regions. FIG. 4B demonstrates the ability of an NTM to acquire a full image of local thermal resistance and/or absolute surface temperature at a spatial resolution of 110 nm, with finer spatial resolutions possible by choosing the image area and pixel density appropriately.

### NTM Probe/Sample Contact Area

As with other thermoreflectance techniques, the size of the heater is the dominant source of uncertainty in the thermophysical parameters of interest. In contact-mode scanning probe measurements such as NTM, the size of the heater at the tip-sample interface is dictated by the contact mechanics at the junction between the sample and the tip. Therefore, quantifying thermal parameters with NTM involves understanding the contact mechanics problem and how the experimental parameters can facilitate or impede NTM's ability to make thermal measurements.

FIG. 5 illustrates the Hertzian contact model for the NTM probe tip 112, which is shown as a spherical indenter in contact with a semi-infinite material half-space. (Other suitable probe tips may be conical, pyramidal, T-shaped, or plateau tips.) The inset is a scanning electron microscopy (SEM) image of a spherical probe tip used in an NTM, highlighting the geometric consistency with the Hertzian contact model. The Hertzian contact model can be used to calculate the contact radius, a, (the contact diameter is twice this value of a and the term “contact area” is used interchangeably in contact mechanics) of the circular footprint where the tip and sample come into contact via

$$a = \sqrt[3]{\frac{3 R F}{4 {k}_{eff}}} ,$$

where R is the effective tip radius, F is the applied force at the tip-sample interface 113 and k_{eff} is the effective contact stiffness. k_{eff} is sometimes referred to as the effective elastic modulus, E*, which combines the elastic properties of the tip and sample materials (elastic moduli, Eₜᵢₚ and Eₛₐₘₚₗₑ, and Poisson's ratio, nₜᵢₚ and nₛₐₘₚₗₑ, for each) into a single effective parameter via

$${k}_{eff} = {E}^{*} = {( \frac{1 - {v}_{tip}^{2}}{{E}_{tip}} + \frac{1 - {v}_{sample}^{2}}{{E}_{sample}} )}^{- 1} .$$

In practice, the effective tip radius R for a given probe tip can be accurately assessed via SEM, and the applied force can be estimated fairly well through careful calibration of cantilever stiffness, k, (often different from the design value in N/m) and the relationship between deflected beam position on the position-sensitive detector (PSD) and piezo stage displacement extracted via a force-distance curve in open-loop operation. The probes used in an NTM are characterized individually by the probe manufacturers, providing probe-specific values of R and k, and the beam-position versus stage displacement is calibrated for each probe via collection of force-distance curves in the NTM system. Therefore, the elastic properties of the material beneath the tip is the sole unknown parameter within the Hertzian contact model for calculating the value of a.

If k_{eff} is not known a priori, it can be characterized experimentally on a pixel-by-pixel basis to increase the accuracy and precision of the calculated value of a, and ultimately the thermal resistance and/or absolute surface temperature extracted in the measurement. One method to extract k_{eff} is via contact resonance microscopy (CRM). An NTM system can use CRM to provide pixel-by-pixel characterization of k_{eff} by monitoring the shift in resonant frequency with position. These changes in frequency that correspond to local k_{eff} are then used to facilitate highly accurate estimates of the contact radius.

Based on the AFM probe's dual-force resonance tracking (DFRT) configuration and demodulator bandwidths, the NTM system waits for a settling time following a perturbation of the cantilever holding the tip in contact with the sample surface. For example, after the NTM system moves to the next pixel in the acquisition grid, it waits for a dwell period for the DFRT feedback loop to stabilize at the resonance frequency for that pixel. As with many homodyne and heterodyne measurements, performing faster parameter sweeps and/or scans involves larger demodulation bandwidths (shorter time constants), leading to more noise power in band and therefore more variation in the output information from the demodulator.

With CRM, the desired scanning speed for image acquisition also affects the uncertainty in the resonance frequency tracked via DFRT; specifically, faster scan speeds (less time per pixel) operate with faster feedback loops (wider loop bandwidths) resulting in less precise determination of the resonance frequency. Since uncertainty in the resonance frequency can translate to uncertainty in contact area via the effective contact stiffness, it is useful to understand the trade-offs between scan speed and thermal parameter precision when imaging materials and devices.

The tip radius and applied force can be varied by the user (e.g., by switching the probe tip), so it is possible to vary the penetration depth of the probe to suit the material/sample of interest. For the two heterointerfaces of interest, the two-dimensional electron gas (2DEG) is typically about 10-30 nm below the top of the donor layer (about 100-150 nm below the top of the SiN passivation layer, if present), whereas the epi/substrate interface could be anywhere from 1-5 μm below the top surface of the sample. The sensitivity at the 2DEG interface can be optimized by selecting a probe radius in a range of about 20-500 nm (e.g., 5-25 nm for GaN with the appropriate probe tips) using an applied force in a range of 0.1 μN to 10 μN.

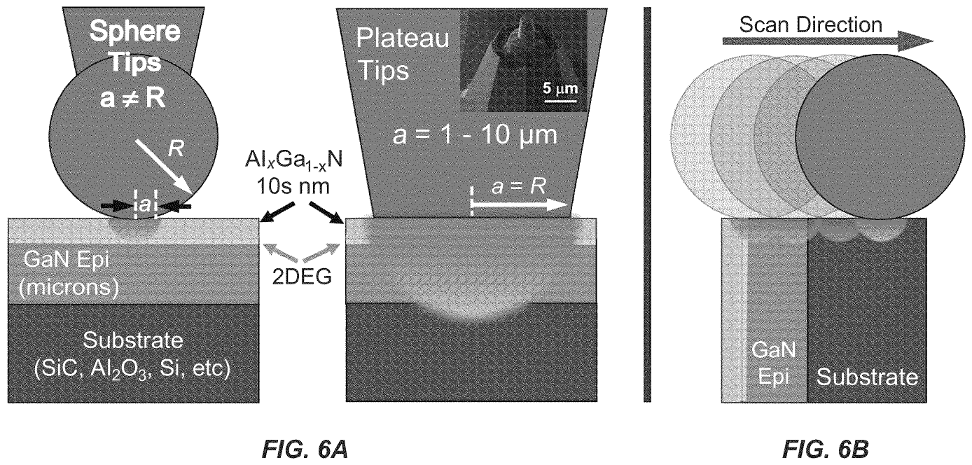

Probing the epi/substrate interface from the top surface may involve a much larger contact radius, e.g., on the order of several microns, across this force range (forces greater than 10 μN risk tip breakage in scanning/imaging mode and should be avoided, if possible). At this scale, the tip may be a curved plateau tip whose surface is a portion of a spherical surface whose radius of curvature is relatively large (e.g., about 0.5-1.0 meters). This slight curvature causes the plateau tip to dilate slightly when it is pushed against the sample. The radius of the plateau tip may be about 1-10 μm as shown in FIG. 6A.

While the ability to probe epi/substrate interface resistances from the top surface as shown in FIG. 6A is desirable, it may not be possible in certain materials stacks where the epi-grown material itself presents significant thermal resistance. An example of this is the AlₓGa₁₋ₓN epi-growth for ultra-wide bandgap (UWBG) HEMT devices. Because the thermal conductivity of the UWBG alloy can be up to an order of magnitude lower than the constitutive III-V semiconductors (AlN and GaN), the thermal resistance of a several-micron-thick layer of this material may dwarf the interface resistance when probing from the surface. In this and other cases like it (particularly in complicated material stacks), the ability to probe the thermal resistances via sample cross-sections allows for accurate characterization of the thermal pathway to thermal ground.

FIG. 6B illustrates how GaN and AlₓGa₁₋ₓN epi layers on different substrates can be cross-sectioned and characterized via an NTM. Sample preparation steps may include mounting in an epoxy puck with subsequent chemical-mechanical polishing, as well as sample dicing and edge-finishing via a focused ion beam (FIB). For each sample, the NTM can characterize thermal resistance as a function of depth through the epi-growth, potentially highlighting any depth-dependent variation due to defect structure associated with the growth conditions. Additionally, the NTM can measure the thermal resistance of the material adjacent to and approaching the epi/substrate heterointerface, taking advantage of the nanoscale lateral resolution to better understand the thermal environment in close proximity to interfaces in nanodevices.

NTM measurement performance depends on scanning speed, among other things. To measure local k_{eff} pixel-by-pixel via CRM for determining contact radius, the per-pixel dwell time should be long enough to perform CRM plus either a resistance or temperature measurement. The per-pixel dwell time to perform these additional measurements can vary due to a variety of experimental factors that affect the signal-to-noise ratio (SNR), including tip size, applied force, material resistivity, device temperature rise, etc. Depending on the SNR for a given measurement, the NTM may spend more or less time per pixel to collect data with the desired performance.

To manage large and/or abrupt height variations in HEMTs and other nanodevices, an NTM may perform an initial, slow topography scan prior to any thermal measurements. This scan may show the locations of the largest changes in height and allow the NTM to react accordingly during subsequent thermal scans. In addition, an additional laser located off-cantilever and positioned directly ahead of the tip scan direction can perform an auto-focusing routine to estimate the relative height of the upcoming areas compared to the current measurement location. Mapping out height variations before thermal measurements reduces the likelihood of damaging the tip or sample.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of measuring a thermal resistance and/or absolute surface temperature of a sample, the method comprising:
placing an atomic force microscope (AFM) probe tip in direct contact with the sample;
modulating a heat flux between the AFM probe tip and the sample;
while modulating the heat flux between the AFM probe tip and the sample, measuring a modulation of a temperature of the AFM probe tip caused by modulation in the heat flux between the AFM probe tip and the sample; and
estimating, based on the modulation of the temperature of the AFM probe tip, the thermal resistance and/or absolute surface temperature of the sample.

2. The method of claim 1, wherein the sample comprises a semiconductor material.

3. The method of claim 1, wherein the sample comprises a nanoscale electronic device.

4. The method of claim 1, wherein modulating the heat flux between the AFM probe tip and the sample comprises modulating a surface area of the AFM probe tip in direct contact with the sample.

5. The method of claim 1, wherein modulating the heat flux between the AFM probe tip and the sample comprises modulating an amplitude of a pump beam illuminating the AFM probe tip.

6. The method of claim 1, wherein modulating the heat flux between the AFM probe tip and the sample comprises modulating a temperature of the sample.

7. The method of claim 1, wherein measuring the modulation of the temperature of the AFM probe tip comprises measuring changes in thermoreflectance of a surface of a cantilever portion of the AFM probe tip.

8. The method of claim 1, wherein measuring the modulation of the temperature comprises performing a lock-in measurement based on a modulation frequency of the heat flux between the AFM probe tip and the sample.

9. The method of claim 1, wherein the sample is hotter than the AFM probe tip and heat flows from the sample to the AFM probe tip.

10. The method of claim 1, wherein the sample comprises an active device, and further comprising:
operating the active device while modulating a surface area of the AFM probe tip in direct contact with the sample.

11. The method of claim 1, further comprising:
heating the AFM probe tip to a temperature hotter than the temperature of the sample with a laser beam absorbed by the AFM probe tip.

12. The method of claim 1, further comprising:
scanning the AFM probe tip across at least a portion of the sample.

13. A nano-probe thermoreflectance microscope comprising:
an atomic force microscope (AFM) probe, having a thermoreflectance that varies with temperature, to directly contact a sample;
a probe laser, in optical communication with the AFM probe, to illuminate the AFM probe with a probe laser beam;
a photodetector, in optical communication with the AFM probe, to detect variations in amplitude of the probe laser beam reflected by the AFM probe, the variations in amplitude of the probe laser beam reflected by the AFM probe representing variations in the thermoreflectance of the AFM probe; and
a processor, operably coupled to the photodetector, to estimate a thermal resistance and/or absolute surface temperature of the sample based at least in part on the variations in the thermoreflectance of the AFM probe.

14. The nano-probe thermoreflectance microscope of claim 13, wherein the AFM probe comprises a spherical tip to make direct contact with the sample.

15. The nano-probe thermoreflectance microscope of claim 13, wherein the processor is configured to estimate a vertical position of the AFM probe with respect to the sample based at least in part on the variations in deflection of the probe laser beam.

16. The nano-probe thermoreflectance microscope of claim 13, further comprising:
a positioning stage to move the sample with respect to the AFM probe so as to modulate a surface area of the AFM probe in direct contact with the sample, thereby modulating a heat flux between the AFM probe and the sample, variations in the heat flux causing the variations in the thermoreflectance of the AFM probe.

17. The nano-probe thermoreflectance microscope of claim 13, further comprising:
a heating laser, in optical communication with the AFM probe, to illuminate the AFM probe with a heating beam at a wavelength absorbed by the AFM probe.

18. The nano-probe thermoreflectance microscope of claim 17, wherein the processor is operably coupled to the heating laser and configured to modulate an amplitude of the heating beam so as to modulate a heat flux between the AFM probe and the sample, variations in the heat flux causing the variations in the thermoreflectance of the AFM probe.

19. The nano-probe thermoreflectance microscope of claim 13, wherein the probe laser is a first probe laser, the photodetector is a first photodetector, and further comprising:
a second probe laser, in optical communication with the AFM probe, to illuminate the AFM probe with a second probe beam at a wavelength reflected and/or scattered by the AFM probe; and
a second photodetector, in optical communication with the AFM probe, to detect a portion of the second probe beam reflected and/or scattered by the AFM probe,
wherein the processor is configured to determine a vertical position of the AFM probe with respect to the sample based at least in part on the portion of the second probe beam detected by the second photodetector.

20. The nano-probe thermoreflectance microscope of claim 19, further comprising:
a pump laser, in optical communication with the AFM probe, to heat the AFM probe with a pump beam; and
a third photodetector, in optical communication with the AFM probe, to detect a portion of the pump beam reflected and/or scattered by the AFM probe,
wherein the processor is configured to control the pump laser based at least in part on the portion of the pump beam detected by the third photodetector.

21. The nano-probe thermoreflectance microscope of claim 13, further comprising:
a lock-in amplifier, operably coupled to the photodetector, to perform a lock-in measurement of the variations in thermoreflectance amplitude of the probe laser beam reflected by the AFM probe based on a modulation frequency of a heat flux between the AFM probe and the sample.

22. The nano-probe thermoreflectance microscope of claim 21, wherein the sample comprises an active device and the lock-in amplifier is configured to modulate a drive current of the active device so as to modulate the heat flux between the AFM probe and the sample.

23. The nano-probe thermoreflectance microscope of claim 21, wherein the sample comprises an active device and the lock-in amplifier is configured to modulate a surface area of the AFM probe and the sample so as to modulate the heat flux between the AFM probe and the sample.
